(19) United States
(12) Patent Application Publication
(10) Pub. No.: US 2026/0063756 A1
(43) Pub. Date: Mar. 5, 2026

(54) METHOD AND APPARATUS FOR EVALUATING RADAR DATA FROM A RADAR SENSOR

(71) Applicant: Robert Bosch GmbH, Stuttgart (DE)

(72) Inventor: Benedikt Loesch, Stuttgart (DE)

(21) Appl. No.: 19/289,642

(22) Filed: Aug. 4, 2025

(30) Foreign Application Priority Data
Aug. 28, 2024 (DE) 10 2024 208 167.1

(51) Int. Cl. G01S 7/35; G01S 13/58

(52) U.S. Cl. CPC G01S 7/354; G01S 13/584; G01S 7/356

(57) ABSTRACT

In a method for evaluating radar data from a radar sensor, the radar sensor generates respective radar data in a plurality of measurement cycles. The radar data are reduced to partial radar data by means of a restriction. The partial radar data correspond to a predetermined parameter range of a radar spectrum. The partial radar data are evaluated. The present invention also relates to an apparatus for evaluating radar data from a radar sensor.

### CROSS REFERENCE

The present application claims the benefit under 35 U.S.C. § 119 of Germany Patent Application No. 10 2024 208 167.1 filed on Aug. 28, 2024, which is expressly incorporated herein by reference in its entirety.

### FIELD

The present invention relates to a method and an apparatus for evaluating radar data from a radar sensor.

### BACKGROUND INFORMATION

A variety of methods for modulating radar signals are described in the related art. The modulated radar signals are emitted, reflected by objects, and the reflected radar signals are received again in order to ascertain the distances, relative velocities, and/or angular positions of the objects.

One well-known modulation method is the so-called chirp sequence method, in which a packet of fast frequency ramps or chirps having a duration T_{f} is emitted. This is followed by a pause T_{P}. A packet of chirps followed by a pause corresponds to a measurement cycle having the duration T_{f}+T_{P}.

An alternative method for radar modulation is orthogonal frequency division multiplexing (OFDM), in which the bandwidth BW is sampled using a plurality of orthogonal subcarriers. The temporal sampling is carried out by emitting multiple so-called OFDM symbols.

A method for acquiring at least two targets with a radar sensor and a corresponding radar sensor is described in German Patent Application No. DE 10 2014 223 990 A1. United States Patent No. U.S. Pat. No. 10,921,436 B2 moreover describes a resolution of a velocity ambiguity of a reflector by encoding MIMO RADAR transmitter frequencies.

### SUMMARY

The present invention provides a method and an apparatus for evaluating radar data from a radar sensor.

Preferred embodiments of the present invention are disclosed herein.

According to a first aspect, the present invention relates to a method for evaluating radar data from a radar sensor. The radar sensor generates respective radar data in a plurality of measurement cycles. The radar data are reduced to partial radar data by means of a restriction. The partial radar data correspond to a predetermined parameter range of a radar spectrum. The partial radar data are evaluated.

According to a second aspect, the present invention relates to an apparatus for evaluating radar data from a radar sensor comprising an interface that receives radar data generated by means of the radar sensor in a plurality of measurement cycles. A computing device reduces the radar data to partial radar data by means of a restriction, wherein the partial radar data correspond to a predetermined parameter range of a radar spectrum. The computing device also evaluates the partial radar data.

In radar measurements, the resolution of distance (Δ) depends on the bandwidth BW being used. The resolution of relative velocity (Δ) depends on the measurement duration T_{f}:

$$Δ d = \frac{c}{2 B W} , Δ v = \frac{c}{2 {f}_{0} {T}_{f}} .$$

c is the speed of light and f₀ is the center frequency of the radar modulation. For an unambiguous distance measurement without undersampling up to the maximum distance or range dₘₐₓ, with equidistant sampling,

$$N = {d}_{max} / Δ d$$

sampling values have to be distributed across the bandwidth BW. For an unambiguous measurement of the relative velocity over a relevant relative velocity interval [vₘᵢₙ, vₘₐₓ], with equidistant sampling,

$$M = ( {v}_{max} - {v}_{min} ) / Δ v$$

temporal sampling values have to be distributed over the measurement duration.

The maximum measurement duration T_{f} in a single packet may be limited, for example due to requirements relating to the maximum unambiguously measurable relative velocity, the maximum permissible latency until the output of radar localizations, or relating to thermal aspects.

Jointly evaluating radar data from several measurement cycles (for example several chirp packets) makes it possible to significantly increase the effective measurement duration, which significantly improves the signal-to-noise ratio and the resolution of relative velocity compared to the single measurement cycle.

The joint evaluation of several measurement cycles requires that the radar data of all measurement cycles be stored together in the memory of the radar sensor or, when the data is processed on a central control device, they have to be transferred, which places certain demands on the transfer speed.

The method according to the present invention reduces the radar data in a suitable manner for cross-cycle evaluation. The method according to the present invention can also be implemented in parallel with a conventional signal processing flow for a single cycle.

The present invention thus ultimately provides using suitable criteria and signal processing to reduce the amount of raw data or radar data such that cross-cycle evaluation is applied only to relevant regions within a range, in a Doppler spectrum and in an angle, in particular azimuth angle and/or elevation angle. The relevant areas are selected such that the performance advantage for the relevant use cases is maintained.

Suitable data reduction can be enabled so that the performance advantage for the relevant use cases is maintained, for instance, while at the same time significantly reducing the amount of data needed and also the computational effort for the cross-cycle evaluation.

The method of the present invention is moreover not limited to a single radar sensor, but can also be used in a cooperative radar sensor network.

According to one example embodiment of the method of the present invention for evaluating radar data from the radar sensor, parameters of the predetermined parameter range comprise at least one of a distance, a relative velocity, an azimuth angle and an elevation angle.

According to another example embodiment of the method of the present invention for evaluating radar data from the radar sensor, parameters of the predetermined parameter range comprise a first distance range that is closer to the radar sensor than a second distance range. This makes it possible to improve a signal-to-noise ratio and thus provide increased sensitivity of the radar sensor, in particular for targets at long distances. This is important in particular because radar reception power scales with the fourth power of the distance, which can also be referred to as free-space attenuation.

Improved Doppler separation capability can contribute to being able to separate two targets with a certain horizontal or vertical separation at a great distance or at a greater distance better or even at all, for example, because an angular difference between these two targets is typically small so that they often cannot be separated in terms of their angle.

According to another example embodiment of the method of the present invention for evaluating radar data from the radar sensor, the first distance range corresponds to a distance range from half a maximum range of the radar sensor to the maximum range of the radar sensor. Thus, limiting the cross-cycle evaluation, for example to the second half of the range-Doppler spectrum, cannot lead to a significant reduction in performance, and, at the same time, the amount of radar data to be stored, namely the partial radar data, can be approximately halved.

According to another example embodiment of the method of the present invention for evaluating radar data from the radar sensor, parameters of the predetermined parameter range comprise a relative velocity, wherein the relative velocity is substantially zero and/or substantially corresponds to a velocity of the radar sensor. This makes it possible to provide a common use case, namely detection and separation of stationary targets or detection of targets with a relative velocity close to zero, i.e. in particular an adaptive cruise control (ACC) target object, or both.

According to another example embodiment of the method of the present invention for evaluating radar data from the radar sensor, modulation sequences of the radar spectrum are coherently summed by means of digital beamforming such that the predetermined parameter range in which the relative velocity is substantially zero or substantially corresponds to a velocity of the radar sensor is amplified. Moreover, other targets, i.e. those in a parameter range different from the predetermined parameter range, can be suppressed. With typically four modulation sequences, this can lead to a reduction of the radar data by a factor of 4 in the case of one relevant velocity range or by a factor of 2 in the case of two relevant velocity ranges.

Digital beamforming can be applied using a delay- and -sum beamformer, for instance, or a minimum variance distortionless response (MVDR) beamformer. As described above, digital beamforming can be used in a modulation method described in Germany Patent Application No. DE 10 2014 212 280 A1, in particular according to paragraphs [0009] to [0024], Germany Patent Application No. DE 10 2014 212 284 A1, in particular according to paragraphs [0011] to [0035], or Germany Patent Application No. DE 10 2017 200 317 A1, in particular according to paragraphs to. If a conventional chirp sequence method is used, certain Doppler cells can alternatively be selected, which, however, exhibit ambiguity in the relative velocity.

According to another example embodiment of the method of the present invention for evaluating radar data from the radar sensor, the radar sensor comprises a plurality of receiving antennas for receiving receive signals, and the receive signals are coherently summed by means of digital RX beamforming such that the predetermined parameter range is amplified. With typically four receiving antennas, this can lead to a reduction of the radar data by a factor of 4 in the case of one direction or a factor of 2 in the case of two directions. Digital RX beamforming can be applied using a delay- and -sum beamformer, for instance, or a minimum variance distortionless response (MVDR) beamformer. The predetermined parameter range can include targets in the direction of travel, specific angular ranges when cornering, and/or any other angles, for example. A preferred angle can also be selected depending on the distance.

According to another example embodiment of the method of the present invention for evaluating radar data from the radar sensor, the radar sensor comprises a plurality of receiving antennas and a plurality of transmitting antennas for receiving receive signals, and the receive signals are coherently summed by means of a common digital TX-RX beamforming such that the predetermined parameter range is amplified. With typically four transmitting antennas and four receiving antennas, this can lead to a reduction of the radar data by a factor of 16 in the case of one direction or a factor of 16/5 in the case of five directions. The predetermined parameter range can include targets in the direction of travel, specific angular ranges when cornering, and/or any other angles, for example. A preferred angle can also be selected depending on the distance.

Common digital TX-RX beamforming can be applied using a delay- and -sum beamformer, for instance, or a minimum variance distortionless response (MVDR) beamformer. in an automotive radar sensor, the plurality of transmitting antennas can typically be operated in time-division multiplexing or Doppler division multiplexing (DDM). Prior to coherent processing of the receive signals from the plurality of transmitting antennas, it is necessary to carry out a relative velocity-dependent phase compensation for time-division multiplexing and a velocity-dependent correction of a transmit sequence for DDM.

The time intervals between chirps are often so large that undersampling occurs in the Doppler and Doppler bins are ambiguous. The above-described compensation therefore either has to be carried out for all velocity ambiguities or a restriction is applied to the predetermined parameter range, in which case the parameters of the predetermined parameter range comprise the relative velocity as described above.

The above-described embodiments of the present invention, in particular the different variants of the predetermined parameter ranges, can be used substantially independent of one another. The above-described embodiments, in particular the different variants of the predetermined parameter ranges, can be used individually or at least partially combined with each other. Only a combination of the common digital TX-RX beamforming with the digital RX beamforming could be difficult and may not be possible to combine.

For example, a combined application of the predetermined parameter range, wherein the first distance range corresponds to a distance range from half a maximum range of the radar sensor to the maximum range of the radar sensor, together with the predetermined parameter range, wherein modulation sequences of the radar spectrum are coherently summed by means of digital beamforming such that the predetermined parameter range in which the relative velocity is substantially zero or substantially corresponds to a velocity of the radar sensor is amplified, and together with the predetermined parameter range, wherein the receive signals are coherently summed by means of a common digital TX-RX beamforming such that the predetermined parameter range in which targets are present in the direction of travel is amplified, can provide a reduction in the amount of data, i.e. the radar data, up to factor 2*4*16=128.

According to another example embodiment of the method of the present invention for evaluating radar data from the radar sensor, reducing the radar data is also carried out dynamically. Dynamic generation makes it possible to further improve the reduction to partial radar data. Reducing the radar data can also be carried out based on detections in a single cycle using information from tracked objects, for example, or based on map information.

The predetermined parameter range in which relevant targets have been identified can be evaluated over multiple measurement cycles, for instance; i.e. the number of measurement cycles can be increased.

The evaluation of the radar data can optionally include a coherent combination of the radar data that have been acquired in the measurement cycles at the spectral level. This can further increase the Doppler resolution and/or the signal-to-noise ratio, for example. The radar sensor can also operate according to a chirp sequence method, for example, or an OFDM method.

The chirp packets or measurement cycles can internally use any arrangement and coding, for example temporally non-equidistant sequences of chirps for unambiguous relative velocity measurement or Doppler division multiplexing (DDM) codes for MIMO methods. The center frequency of the chirps within a chirp packet can be varied as well, for example increase linearly or decrease linearly.

The parameters of the chirp packets can also be varied from measurement cycle to measurement cycle. For example, the sign of a slope of the chirps, the sign of a change in the center frequency of the individual chirps in the chirp packet, a bandwidth of the chirps, an amount of change in the center frequency and/or ramp timings can be varied. This has the advantage that measurements of the individual measurement cycles are uncorrelated. When jointly evaluating the multiple chirp packets, such changes can be taken into account as appropriate.

The computing device can be integrated into the radar sensor, for instance, or it can be configured as or integrated into a central control device.

All method steps or processing steps of the method according to the present invention, or individual ones thereof, can be carried out on the radar sensor itself or on a central control device. The central control device can comprise more computing resources or memory than the radar sensor, for instance. When implemented on the central control device, it is advantageous to transfer the radar data to the central control device after the reducing method step.

Further advantages, features and details of the present invention will emerge from the following description, in which different embodiment examples of the present invention are described in detail with reference to the figures.

### BRIEF DESCRIPTION OF THE DRAWINGS

FIG. 1 shows a schematic block diagram of a radar sensor comprising an apparatus for evaluating radar data from the radar sensor according to one example embodiment of the present invention.

FIG. 2 shows a flow chart of an example signal processing flow of a cross-cycle processing in parallel with a single-cycle processing.

FIG. 3 shows example variants of a time and frequency scheme of the radar data.

FIG. 4 shows a flow chart of a method for evaluating radar data from a radar sensor according to another example embodiment of the present invention.

### DETAILED DESCRIPTION OF EXAMPLE EMBODIMENTS

In all figures, identical or functionally identical elements and devices are provided with the same reference sign. The numbering of method steps is for the sake of clarity and is generally not intended to imply a specific chronological order. It is in particular also possible to carry out multiple method steps at the same time.

The present invention is described using the chirp sequence method as an example. However, the present invention can alternatively also analogously be applied to the OFDM method.

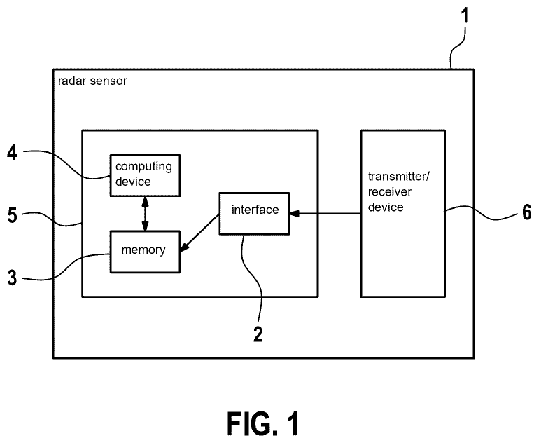

FIG. 1 shows a schematic block diagram of a radar sensor 1 comprising an apparatus 5 for evaluating radar data from the radar sensor 1. The apparatus 5 can be part of the radar sensor 1 or external.

The apparatus 5 comprises an interface 2 that receives radar data generated by a transmitter/receiver device 6 of the radar sensor 1 in a plurality of measurement cycles. The radar data are stored in a memory 3. A computing device 4 reduces the radar data to partial radar data by means of a restriction, wherein the partial radar data correspond to a predetermined parameter range of a radar spectrum.

The computing device 4 can carry out radar processing of the radar data using conventional methods for radar modulation, for example the chirp sequence method or orthogonal frequency division multiplexing (OFDM).

The computing device 4 ascertains a radar spectrum. The parameters of the radar spectrum include a distance, a relative velocity, an azimuth angle, an elevation angle, or a selection (subset) thereof, for example.

The partial radar data can be stored in the memory 3. The radar spectrum can be divided into at least one predetermined parameter range.

The computing device 4 evaluates the partial radar data. The radar data stored over the respective number of measurement cycles can first be combined for the predetermined parameter range. Multi-frame integration (MFI) methods can be used, such as chirp sequence 3D methods as described in United States Patent Application No. US 2020/0408879 A1, for instance, keystone methods or backprojection methods. In this way, a plurality of high-resolution partial radar images can be obtained by combining the radar data of a plurality of measurement cycles.

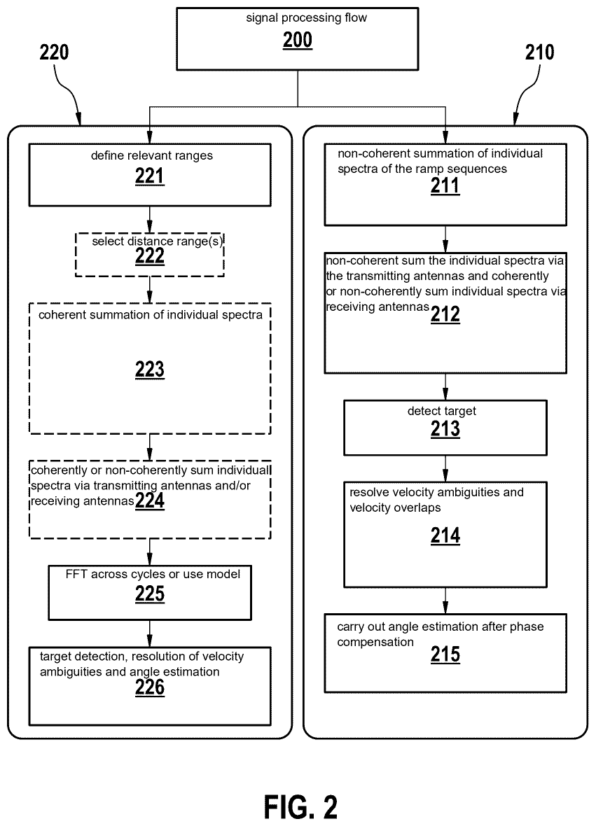

FIG. 2 shows a flow chart of an example signal processing flow 200 of a cross-cycle processing in parallel with a single-cycle processing;

The right side of the flow chart shows a standard signal processing flow 210 for a single cycle. The standard signal processing flow 210 can be carried out in parallel with a flow 220 shown on the left side of the flow chart for cross-cycle processing with a suitable reduction in radar data.

Before the flows 210 and/or 220 are carried out, a two-dimensional Fourier transformation (fast Fourier transform, FFT) can be carried out for each ramp sequence and optionally for each receiving channel.

The standard signal processing flow 210 can include a non-coherent summation of individual spectra of the ramp sequences for each transmitting and receiving antenna in Step 211, for example. In Step 212, the individual spectra can furthermore be non-coherently summed via the transmitting antennas and the individual spectra can be coherently or non-coherently summed via the receiving antennas. In a further Step 213, a target can be detected by dividing a distance/velocity parameter range as a function of a ratio of a signal power of the radar radiation of the respective parameter range to a constant false alarm rate (CFAR) threshold value including a peak interpolation. Velocity ambiguities and velocity overlaps can be resolved in Step 214. A transmitter assignment can optionally be carried out as well; for example as described in the Germany Patent Application Nos. DE 10 2014 212 280 A1, DE 10 2014 212 284 A1, DE 10 2017 200 317 A1 or DE 10 2014 223 990 A1. An angle estimation can furthermore be carried out in Step 215 after a phase compensation; for example as described in Germany Patent Application Nos. DE 10 2014 212 284 A1 or DE 10 2014 223 990 A1. A transmitter assignment can likewise be carried out here as well; for example as described in German Patent Application No. DE 10 2017 200 317 A1.

In Step 221, relevant ranges within a range, in a Doppler spectrum and at an angle, in particular azimuth angle and/or elevation angle, can be defined in the flow 220 for cross-cycle processing with a suitable reduction of the radar data. for example. In a further Step 222, one or more distance ranges can be selected for the predetermined parameter range (so-called range bins). In Step 223, for example, a coherent summation of individual spectra of the ramp sequences for each transmitting and receiving antenna can furthermore be provided by means of velocity beamforming. It is alternatively also possible to select so-called Doppler bins. In Step 224, the individual spectra can also be coherently or non-coherently summed via the transmitting antennas and/or the receiving antennas. Steps 222, 223 and 224 for reducing radar data do not all have to be carried out; individual steps can be skipped.

The subsequent Step 225 can be carried out using a Fourier transformation (fast Fourier transform, FFT) across the cycles taking into account relative object movement, or model-based using a single-target or multi-target model for expected measurement signals of a range-Doppler bin of the single measurement cycle. In a further Step 226, in particular a concluding Step 226, target detection, resolution of velocity ambiguities and angle estimation can be carried out, provided that these two processes have not already been carried out during the reduction of the radar data. Refinement can optionally take place in the angle estimation, if digital beamforming was carried out for multiple directions during the reduction of the radar data.

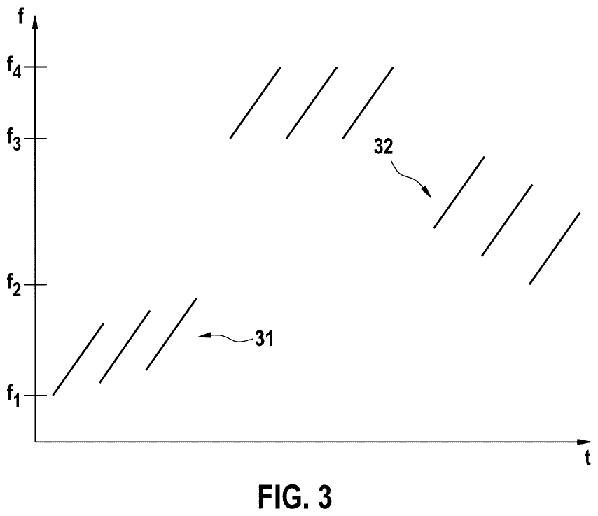

FIG. 3 shows example variants of a time and frequency scheme of the radar data. Specifically, the time and frequency scheme illustrates frequencies f over a time t.

A center frequency of the chirps within a chirp packet can be varied, for instance. The center frequency can in particular increase linearly as shown at 31 or decrease linearly as shown at 32.

The parameters of the chirp packets can also be varied from measurement cycle to measurement cycle. For example, the sign of the slope of the chirps, the sign of the change in the center frequency of the individual chirps in the chirp packet, the bandwidth of the chirps, the amount of change in the center frequency and/or the ramp timings can be varied.

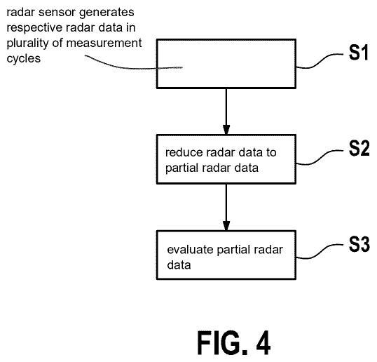

FIG. 4 shows a flow chart of a method for evaluating radar data from a radar sensor, for example the above-described radar sensor 1.

In a first step S1, the radar sensor 1 generates respective radar data in a plurality of measurement cycles.

In a step S2, the radar data are reduced to partial radar data by means of a restriction. The partial radar data correspond to a predetermined parameter range of a radar spectrum. The parameters of the predetermined parameter range can comprise at least one of a distance, a relative velocity, an azimuth angle and an elevation angle.

In a step S3, the partial radar data are evaluated. For this purpose, the radar data that correspond to the predetermined parameter range over the plurality of measurement cycles, i.e. the partial radar data, can first be combined.

In one variant, parameters of the predetermined parameter range can comprise a first distance range that is closer to the radar sensor 1 than a second distance range. Improved Doppler separation capability can contribute to being able to separate two targets with a certain horizontal or vertical separation at a great distance or at a greater distance better or even at all, for example, because an angular difference between these two targets is typically small so that they often cannot be separated in terms of their angle. The first distance range can correspond to a distance range from half a maximum range of the radar sensor 1 to the maximum range of the radar sensor 1. Thus, limiting the cross-cycle evaluation, for example to the second half of the range-Doppler spectrum, cannot lead to a significant reduction in performance, and, at the same time, the amount of radar data to be stored, namely the partial radar data, can be approximately halved.

Alternatively or additionally, parameters of the predetermined parameter range can comprise a relative velocity, wherein the relative velocity is substantially zero and/or substantially corresponds to a velocity of the radar sensor 1. This makes it possible to provide a common use case, namely detection and separation of stationary targets or detection of targets with a relative velocity close to zero, i.e. in particular an adaptive cruise control (ACC) target object, or both. Modulation sequences of the radar spectrum can be coherently summed by means of digital beamforming such that the predetermined parameter range in which the relative velocity is substantially zero or substantially corresponds to a velocity of the radar sensor 1 is amplified. Moreover, other targets, i.e. those in a parameter range different from the predetermined parameter range, can be suppressed. With typically four modulation sequences, this can lead to a reduction of the radar data by a factor of 4 in the case of one relevant velocity range or by a factor of 2 in the case of two relevant velocity ranges.

Alternatively or additionally, the radar sensor 1 can comprise a plurality of receiving antennas for receiving receive signals, wherein the receive signals are coherently summed by means of digital RX beamforming such that the predetermined parameter range in which targets are present in the direction of travel is amplified. With typically four receiving antennas, this can lead to a reduction of the radar data by a factor of 4 in the case of one direction or a factor of 2 in the case of two directions. Digital RX beamforming can be applied using a delay- and -sum beamformer, for instance, or a minimum variance distortionless response (MVDR) beamformer.

Alternatively or additionally, the radar sensor 1 can comprise a plurality of receiving antennas and a plurality of transmitting antennas for receiving receive signals, wherein the receive signals are coherently summed by means of common digital TX-RX beamforming such that the predetermined parameter range in which targets are present in the direction of travel is amplified. With typically four transmitting antennas and four receiving antennas, this can lead to a reduction of the radar data by a factor of 16 in the case of one direction or a factor of 16/5 in the case of five directions.

Common digital TX-RX beamforming can be applied using a delay- and -sum beamformer, for instance, or a minimum variance distortionless response (MVDR) beamformer. in an automotive radar sensor, the plurality of transmitting antennas can typically be operated in time-division multiplexing or Doppler division multiplexing (DDM).

Prior to coherent processing of the receive signals from the plurality of transmitting antennas, it is necessary to carry out a relative velocity-dependent phase compensation for time-division multiplexing and a velocity-dependent correction of a transmit sequence for DDM. The time intervals between chirps are often so large that undersampling occurs in the Doppler and Doppler bins are ambiguous. The above-described compensation therefore either has to be carried out for all velocity ambiguities or a restriction is applied to the predetermined parameter range, in which case the parameters of the predetermined parameter range comprise the relative velocity as described above.

Reducing S2 the radar data can also be carried out dynamically, for example. Reducing S2 the radar data can also be carried out based on detections in a single cycle using information from tracked objects, for example, or based on map information.

Even though the present invention has been explained above with reference to embodiment examples, it is not limited thereto and can instead be modified in a variety of ways. Combinations of the above embodiment examples are in particular possible as well.

What is claimed is:

1. A method for evaluating radar data from a radar sensor, comprising the following steps:
generating respective radar data using the radar sensor in a plurality of measurement cycles;
reducing the radar data using a restriction on partial radar data that correspond to a predetermined parameter range of a radar spectrum; and
evaluating the partial radar data.

2. The method according to claim 1, wherein parameters of the predetermined parameter range include at least one of a distance, a relative velocity, an azimuth angle, and an elevation angle.

3. The method according to claim 1, wherein parameters of the predetermined parameter range include a first distance range that is closer to the radar sensor than a second distance range.

4. The method according to claim 3, wherein the first distance range corresponds to a distance range from half a maximum range of the radar sensor to the maximum range of the radar sensor.

5. The method according to claim 1, wherein parameters of the predetermined parameter range include a relative velocity, wherein the relative velocity is substantially zero and/or substantially corresponds to a velocity of the radar sensor.

6. The method according to claim 5, wherein modulation sequences of the radar spectrum are coherently summed using digital beamforming such that the predetermined parameter range in which relative velocity is substantially zero or substantially corresponds to a velocity of the radar sensor is amplified.

7. The method according to claim 1, wherein the radar sensor includes a plurality of receiving antennas for receiving receive signals, and wherein the receive signals are coherently summed using digital RX beamforming such that the predetermined parameter range is amplified.

8. The method according to claim 1, wherein the radar sensor includes a plurality of receiving antennas and a plurality of transmitting antennas for receiving receive signals, and wherein the receive signals are coherently summed using a common digital TX-RX beamforming such that the predetermined parameter range is amplified.

9. The method according to claim 1, wherein reducing the radar data is also carried out dynamically.

10. An apparatus for evaluating radar data from a radar sensor, comprising:
an interface configured to receive radar data generated using the radar sensor in a plurality of measurement cycles; and
a computing device configured to reduce the radar data to partial radar data using a restriction, wherein the partial radar data correspond to a predetermined parameter range of a radar spectrum;
wherein the computing device is further configured to evaluate the partial radar data.
